(19) United States
(12) Patent Application Publication
(10) Pub. No.: US 2005/0039579 A1
(43) Pub. Date: Feb. 24, 2005

(54) Device for increasing a force applied by a wrench

(76) Inventor: Nathaniel Thomas Wallace, Beechhurst, NY (US)

Correspondence Address: Nathaniel T. Wallace;F. CHAU & ASSOCIATES, LLP, Suite 501, 1900 Hempstead Turnpike, East Meadow, NY, 11554, US

(21) Appl. No.: 10/644,144

(22) Filed: Aug. 20, 2003

(51) Int. Cl. B25B 17/00

(52) U.S. Cl. 81/57.3

(57) ABSTRACT

A tool comprises a drive gear comprising a hollowed interior portion, including teeth disposed on an inner wall, the drive gear comprising a drive member disposed on a bottom portion of the drive gear, the drive member for applying a first force, an intermediate gear cooperating with the teeth disposed inward, the intermediate gear having a fixed position within the drive gear, and a primary gear disposed within the drive gear, cooperating with the intermediate gear, the primary gear for receiving a second force less than the first force.

### BACKGROUND OF THE INVENTION

1. Field of the Invention

The present invention relates to hand tools, and more particularly to a device to increasing a force applied by the wrench.

2. Discussion of Related Art

Wrenches, such as ratchet wrenches and breaker bars, are used to tighten and loosen nuts, bolts, and other fixation means. When a force needed to tighten or loosen the fixation means is greater than a user is capable of comfortably applying with a given wrench, the user may be unable to accomplish a desired task.

One method for applying the needed force is to implement a longer wrench, thus increasing the amount of force applied to the fixation means for a given amount of force applied to an end of the wrench. In some cases it may be undesirable to use a longer wrench, such as when a workspace is limited in size, or when it would be undesirable to carry different sized wrenches.

Therefore, a need exists for a device that is capable to increasing a force applied to a fixation means without the need for a longer wrench.

### SUMMARY OF THE INVENTION

According to an embodiment of the present invention, a tool comprises a drive gear comprising a hollowed interior portion, including teeth disposed on an inner wall, the drive gear comprising a drive member disposed on a bottom portion of the drive gear, the drive member for applying a first force, an intermediate gear cooperating with the teeth disposed inward, the intermediate gear having a fixed position within the drive gear, and a primary gear disposed within the drive gear, cooperating with the intermediate gear, the primary gear for receiving a second force less than the first force.

The primary gear is located at a center of the drive gear. The primary gear comprises a socket exposed to an exterior of the drive gear.

The drive gear further comprises a removable top portion.

At least one of the primary gear, the intermediate gear, and the teeth of the drive gear are removable.

The primary gear, the intermediate gear, and the drive gear are arranged on a horizontal plane.

### BRIEF DESCRIPTION OF THE FIGURES

Preferred embodiments of the present invention will be described below in more detail, with reference to the accompanying drawings:

FIG. 1 is a cross-section of a bottom view of a device according to an embodiment of the present invention;

FIG. 2 is a cross-section of a side view of a device according to an embodiment of the present invention;

FIG. 3 is a view of a bottom portion of a device according to an embodiment of the present invention;

FIGS. 4A and 4B are views of a primary gear according to an embodiment of the present invention;

FIG. 5A is a cross-section of a device according to an embodiment of the present invention; and

FIG. 5B is a top view of a device according to an embodiment of the present invention.

### DETAILED DESCRIPTION OF PREFERRED EMBODIMENTS

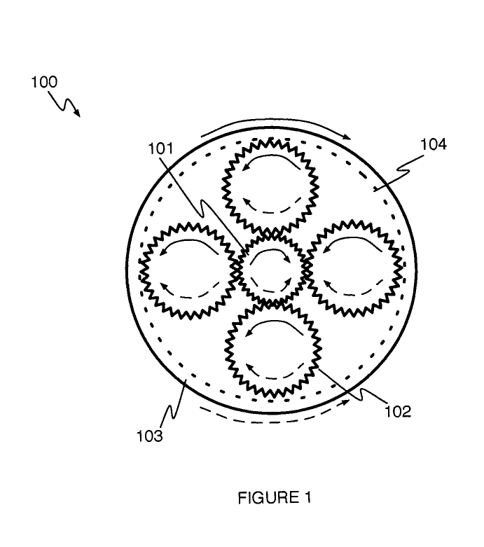

Through the gearing of a hand tool, such as a wrench, additional leverage can be obtained on a fixation means, e.g., a bolt or a nut. Referring to FIG. 1, a device 100 comprises a plurality of gears, including a primary gear 101, an intermediate gear 102, and a drive gear 103.

The drive gear 103 comprises teeth on the inside wall 104, cooperating with the intermediate gear 102. The primary gear 101 cooperates with the intermediate gears 102. While FIG. 1 depicts four intermediate gears 102, any number of intermediate gears 102 can be implemented.

In FIG. 1, the solid arrows indicate a first direct of the gears 101-103. The dotted arrows indicate a second direction of the gears 101-103. As can be seen in FIG. 1, the direction of rotation of the drive gear 103 matches the direction of rotation of the primary gear 101, and that the intermediate gear 102 rotate counter to the primary gear 101 and the drive gear 103.

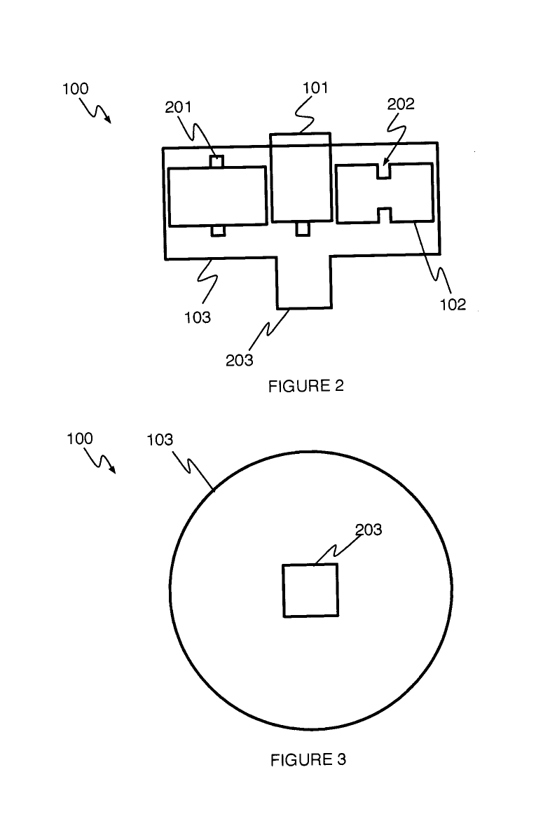

Referring to FIG. 2, the cooperation of the gears 101-103 results in a geared effect on a drive shaft 106 of the drive gear 103. As shown in FIG. 2, the primary gear 101, the intermediate gears 102, and the drive gear 103 are arranged on a horizontal plane. Depending on the size of the gears 101-103, different ratios can be implemented. Similarly, different ratios can be implemented by varying the number of teeth on one or more gear(s) 101-103. According to an embodiment of the present invention, an input on the primary gear 101 having a distance of X is translated into an output of the drive gear 103 having a distance Y, where Y less than X. Accordingly, a torque applied to the primary gear 101 is increased through the gearing and output by the drive gear 103.

The intermediate gears 102 are rotate about fixed positions relative to the drive gear 103. The intermediate gears can be fixed by, for example, pins 201 fitting in corresponding holes of the drive gear or holes 202 corresponding to pins of the drive gear 103. Other means for positioning the intermediate gears are possible, such as walls within the drive gear 103.

As shown in FIGS. 2 and 3, the drive gear 103 comprises a drive member 203, which fits into socket type tools. Alternatively, the drive member 203 can be a particular tool, such as a socket type tool or a Phillips type drive.

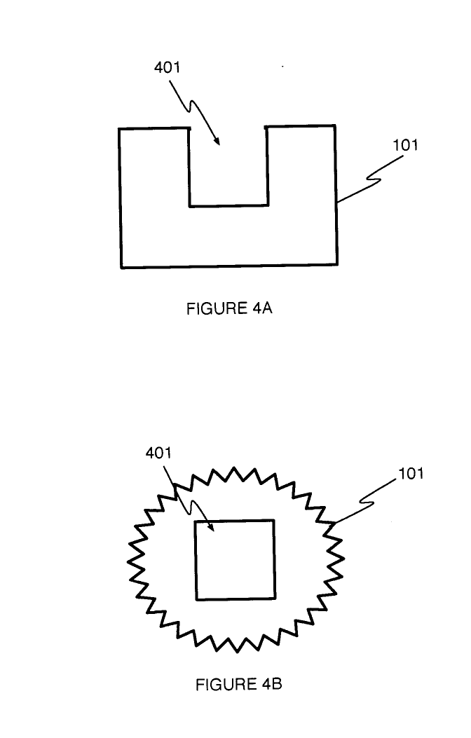

Referring to FIG. 4A and FIG. 4B, the primary gear 101 comprises a socket 401 for receiving a drive member of a tool, such as that of a ratchet wrench. Accordingly, the device 100 can be used with widely available hand tools. Further, one skilled in the art would appreciate that the drive shaft 106 can received any tool capable of being used with socket type hand tools. It should also be noted that the term hand tool is not limiting to any particular class of tools, and that the device 100 of the present invention, can be used with for example, ratchet wrenches, breaker bars, pneumatic tools, screw drivers, etc. Alternatively, the primary gear can be fixed to a handle. The handle can comprise additional functionality, for example, a torque-sensing device. According to an embodiment of the present invention, a torque-sensing device is designed according to a known gearing of the device 100.

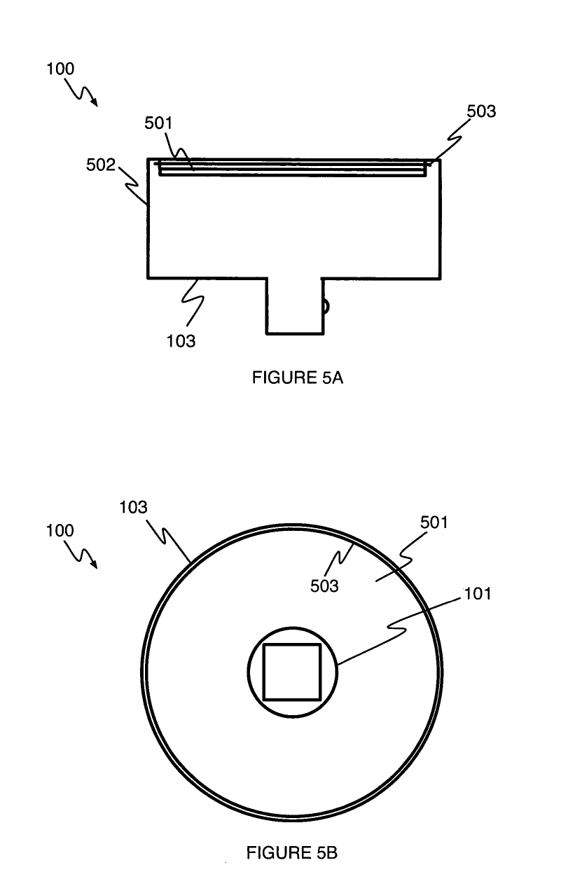

According to an embodiment of the present invention, the gears 101-103 of the device 100 can be swapped out, allowing a user to change a gearing of the device 100. Referring to FIGS. 5A and 5B, a top portion 501 of the device 100 is secured to a body 502 of the drive gear 103. For example, a “C” clip 503, which fits into a groove of the body 503, secures the top portion 501 to the body 502 of the drive gear 103, wherein the top portion 501 fits below the clip 503 in the body 502. The top portion 501 can be held in place by other means; for example, the top portion 501 can be screwed into place, wherein the top portion 501 and the body 502 comprise cooperating threads. By removing the top portion 501, access can be had to the gears for, for example, service and changing gear ratios.

It should be noted that while the drive gear 103 is depicted as having a round exterior shape, other shapes can be implemented, for example, a hexagon.

Having described embodiments for a device to increasing a force applied by the wrench, it is noted that modifications and variations can be made by persons skilled in the art in light of the above teachings. It is therefore to be understood that changes may be made in the particular embodiments of the invention disclosed which are within the scope and spirit of the invention as defined by the appended claims. Having thus described the invention with the details and particularity required by the patent laws, what is claimed and desired protected by Letters Patent is set forth in the appended claims.

1. A tool comprising:
a drive gear comprising a hollowed interior portion, including teeth disposed on an inner wall, the drive gear comprising a drive member disposed on a bottom portion of the drive gear, the drive member for applying a first force;
an intermediate gear cooperating with the teeth disposed inward, the intermediate gear having a fixed position within the drive gear; and
a primary gear disposed within the drive gear, cooperating with the intermediate gear, the primary gear for receiving a second force less than the first force.

2. The tool of claim 1, wherein the primary gear is located at a center of the drive gear.

3. The tool of claim 1, wherein the primary gear comprises a socket exposed to an exterior of the drive gear.

4. The tool of claim 1, wherein the drive gear further comprises a removable top portion.

5. The tool of claim 1, wherein at least one of the primary gear, the intermediate gear, and the teeth of the drive gear are removable.

6. The tool of claim 1, wherein the primary gear, the intermediate gear, and the drive gear are arranged on a horizontal plane.
